(19) United States
(12) Patent Application Publication
(10) Pub. No.: US 2014/0121052 A1
(43) Pub. Date: May 1, 2014

(54) PULLEY SYSTEM

(71) Applicant: COMMONWEALTH EDISON COMPANY, Chicago, IL (US)

(72) Inventor: Eric J. Jaeger, Glen Ellyn, IL (US)

(73) Assignee: Commonwealth Edison Company, Chicago, IL (US)

(21) Appl. No.: 13/661,730

(22) Filed: Oct. 26, 2012

(51) Int. Cl. F16H 55/36

(52) U.S. Cl. CPC F16H 55/36
USPC 474/198

(57) ABSTRACT

A pulley system is provided to encourage contact between a pulley and a rope, chain, cord, cable and the like. The pulley system has first and second side legs, an axle, a pulley and at least one guide member. The guide member can be coupled to or formed integrally with at least one of the side legs. The guide member has at least one wall extending outwardly and away from the radial direction of the pulley to act as a funnel and encourage contact between a rope, chain, cable and the like and the pulley, thereby reducing the amount of force required to pull the item.

### CROSS REFERENCE TO RELATED APPLICATIONS

This application is a continuation of and claims the benefit of priority to co-pending U.S. patent application Ser. No. 13/415,368, filed Mar. 8, 2012, which application is a continuation of U.S. patent application Ser. No. 13/068,853, filed Jul. 26, 2010. This application also claims the benefit of priority to co-pending International PCT Patent Application number PCT/US2011/045207, filed Jul. 25, 2011, which application claims the benefit of priority to U.S. patent application Ser. No. 13/068,853, filed Jul. 26, 2010. The entire disclosures of these applications are incorporated by reference herein.

### FIELD OF THE INVENTION

The field of this invention relates generally to pulling wheels or pulleys. More specifically, the field of this invention relates to a pulley system configured to encourage contact between a rope, chain, cord, cable and the like and a pulley during use.

### BACKGROUND OF THE INVENTION

Conventional pulling systems typically comprise a pulley, an axle and a pair of spaced side walls. The axle is mounted between the side walls, and the pulley can be inserted on the axle. A cable or rope, for example, can be placed on the pulley, and as the cable is pulled, the pulley can rotate around the axle. However, if the cable is not positioned inline with the radial direction of the pulley, on either side of the pulley, (e.g., if the cable is being pulled at an acute angle relative to the radial direction of the pulley), the cable can lose contact with the pulley. Also, because there is a distance between the pulley and the side walls, a gap can be created into which the cable can enter and bind the pulley.

In view of the preceding, there is a need for a pulley system to maintain a rope chain, cord, cable and the like in contact with a pulley, and/or prevent or reduce the rope chain, cord, cable and the like from entering the gap between the pulley and side walls of the pulley system.

### SUMMARY

This application relates to a pulley system to encourage contact between a pulley and a rope, chain, cord, cable and the like. In one aspect, the pulley system comprises a first side leg and a second side leg, an axle, and a pulley. In another aspect, the pulley can be rotatably mounted on the axle between the first and second side legs.

In one aspect, the first side leg can comprise a first guide member, and the second side leg can comprise a second guide member. The first and second guide members can be configured to help maintain a cable, wire, rope, chain and the like in contact with the pulley. In another aspect, the first and second guide members can have walls extending outwardly and away from the radial direction of the pulley. Thus, the first and/or second guide members can act to funnel an item such as a cable, wire, rope, chain and the like to a pulling surface of the pulley, thereby reducing the amount of force required to pull the item. In another aspect, at least a portion of the first and/or second guide members can be arcuate having a respective first and/or second guide member diameter.

In use, in one aspect, is not necessary for an item to be pulled with the pulley system, such as a cable, wire, rope, chain and the like, to be lined up in the radial direction of the pulley in the areas adjacent the pulley system. For example, a cable can be positioned at an acute angle relative to the radial direction of the pulley. A first end of the cable can be threaded through the side legs of the pulley system and pulled. As the cable moves, portions of the cable can contact the first or second guide members, which urge the cable towards contact with the pulling surface of the pulley.

### DETAILED DESCRIPTION OF THE FIGURES

These and other features of the preferred embodiments of the invention will become more apparent in the detailed description in which reference is made to the appended drawings wherein:

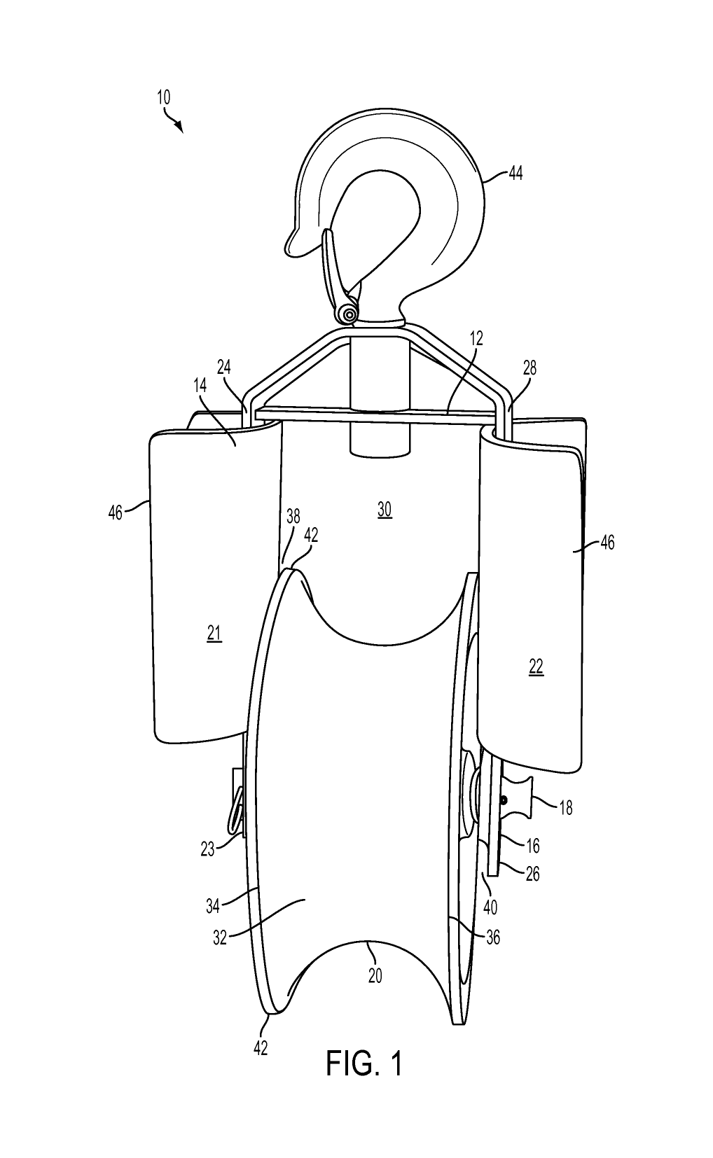

FIG. 1 is a perspective view of a pulley system, according to one aspect.

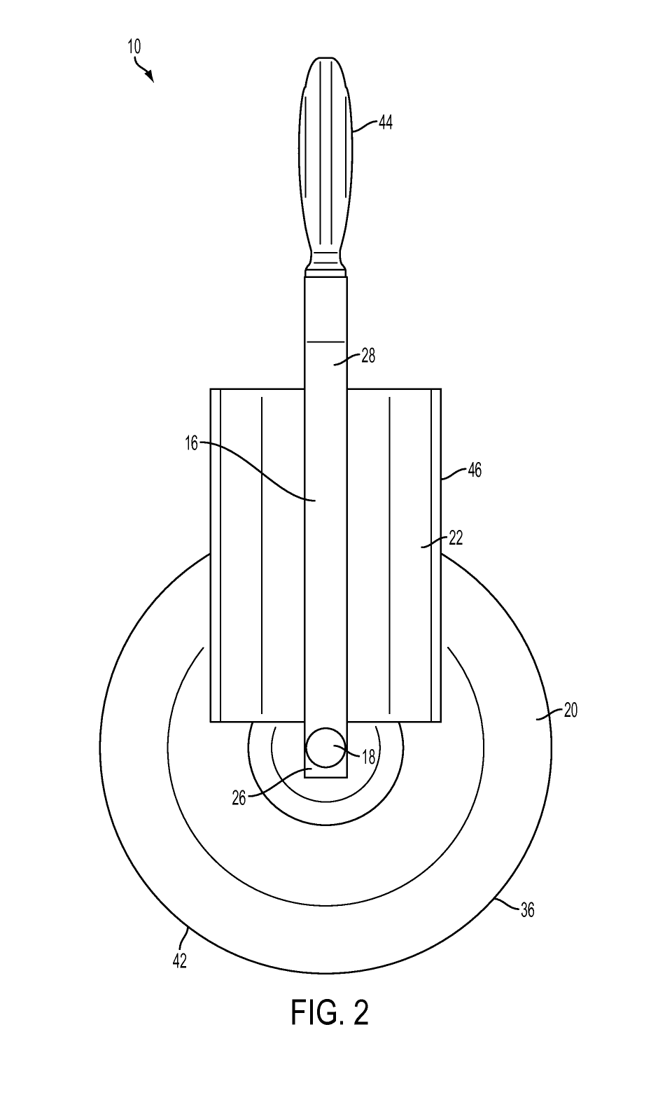

FIG. 2 is a side elevational view of the pulley system of FIG. 1.

### DETAILED DESCRIPTION OF THE INVENTION

Embodiments of the present invention can be understood more readily by reference to the following detailed description, examples, drawing, and claims, and their previous and following description. However, before the present devices, systems, and/or methods are disclosed and described, it is to be understood that embodiments described herein are not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the invention in its best and currently known embodiments. To this end, those skilled in the relevant art will recognize and appreciate that many changes can be made to the various aspects of the invention described herein, while still obtaining the beneficial results of the described embodiments. It will also be apparent that some of the desired benefits of the embodiments of the present invention can be obtained by selecting some of the features described herein without utilizing other features. Accordingly, those who work in the art will recognize that many modifications and adaptations are possible and can even be desirable in certain circumstances and are a part of the embodiments of the present invention. Thus, the following description is provided as illustrative of the principles of the embodiments of the present invention and not in limitation thereof.

As used throughout, the singular forms “a,” “an” and “the” include plural referents unless the context clearly dictates otherwise. Thus, for example, reference to “a port” can include two or more such ports unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

A pulley system 10 is provided, according to various aspects. In one aspect, as illustrated in FIG. 1, the pulley system comprises a top member 12, a first side leg 14, and a second side leg 16, an axle 18 and a pulley 20. In still another aspect, the first side leg can comprise a first guide member 21 configured to help maintain a cable, rope and the like in contact with the pulley. In another aspect, the second side leg can comprise a second guide member 22 configured to help maintain a cable, rope and the like in contact with the pulley 20. In still another aspect, the pulley system can further comprise a mounting hook 44 coupled to the top member 12.

In one aspect, the first side leg 14 and the second side leg 16 can be spaced from and opposed to each other. The first side leg can have a proximal end 23 and a distal end 24, and the second side leg can have a proximal end 26 and a distal end 28. In one aspect, the distal ends of each of the first and second side legs can be coupled to the top member 12. In another aspect, the distal ends 24, 28 of each of the first and second side legs can be coupled to the ends of the top member. In still another aspect, the first side leg 14 and the second side leg 16 can extend downwardly from the top member 12. In another aspect, the first and second side legs can be substantially parallel to each other, though it is contemplated that the first and second side legs can be positioned at an acute angle relative to each other. The axle 18 can be coupled to the proximal ends 23, 26 of each of the first and second side legs, according to one aspect.

In one aspect, the pulley 20 can be rotatably mounted on the axle 18 so that the pulley can be rotated relative to the side legs. In another aspect, the pulley can have a pulling surface 32 extending from a first pulley face 34 to a second pulley face 36. In one aspect, the pulling surface can be substantially straight. Alternatively, and as illustrated in FIG. 1, in another aspect, at least a portion of the pulling surface 32 can be arcuate having a pulling surface diameter. In another aspect, the first pulley face can have a first pulley face diameter, and the second pulley face can have a second pulley face diameter.

In still another aspect, a first pulley gap 38 can be formed between the first pulley face and the first side leg 14, and a second pulley gap 40 can be formed between the second pulley face and the second side leg 16. In another aspect, the first pulley gap 38 and/or the second pulley gap 40 can be about 0 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 40 mm, at least about 50 mm, at least about 60 mm, at least about 70 mm, at least about 80 mm, at least about 90 mm, or at least about 100 mm.

In one aspect, the first and second side legs 14, 16, the top member 12, and the axle 18 or a portion of the pulley 20 can form an enclosed area 30. In another aspect, the first and/or second guide members 21, 22 can have walls 46 extending outwardly and away from the enclosed area 30. Thus, the first and/or second guide members can act to funnel a cable, wire, rope and the like to the pulling surface 32 and more readily through the enclosed area 30.

In another aspect, at least a portion of the walls 46 of the first and/or second guide members 21, 22 can extend away from the pulley 20 at an acute angle relative to the radial direction of the pulley and at an acute angle relative to the axial direction of the pulley 20. In yet another aspect, at least a portion of the first guide member 21 can be arcuate having a first guide member diameter, and at least a portion of the second guide member 22 can be arcuate having a second guide member diameter. In one aspect, the pulling surface diameter can be less than the first guide member diameter and/or the second guide member diameter. In other aspects, the pulling surface diameter can be greater than the first guide member diameter and/or the second guide member diameter, and the pulling surface diameter can be substantially equal to the first guide member diameter and/or the second guide member diameter.

In one aspect, at least a portion of the first and/or second guide members 21, 22 can be, for example, substantially “C” shaped, “U” shaped, “V” shaped, and the like. In another aspect, the first and/or second guide members can be formed from cutting a circular pipe in half lengthwise to create two semi-circular pieces.

The first guide member 21 can have a length less than the distance from the top member 12 to the axle 18 when the pulley system 10 is assembled, according to one aspect. In another aspect, the second guide member 22 can have a length less than the distance from the top member to the axle when the pulley system is assembled. In still another aspect, the first guide member 21 and/or the second guide member 22 can have a length greater than the distance from the top member 12 to an outer edge 42 of the first pulley face 34. In another aspect, the first guide member and/or the second guide member can have a length greater than the distance from the top member to a midpoint between the axle 18 and the outer edge of the first pulley face. In another aspect, the first guide member and/or the second guide member can have a length less than the diameter of the first pulley face 34. In another aspect, the first guide member 21 and/or the second guide member 22 can have a width less than the diameter of the first pulley face. Alternatively, in other aspects, the first guide member and/or the second guide member can have a width substantially equal to the diameter of the first pulley face, and the first guide member 21 and/or the second guide member 22 can have a width greater than the diameter of the first pulley face. In still another aspect, the distance from the top member 12 to the axle 18 can be less than the diameter of the first pulley face 34.

In another aspect, at least a portion of the first guide member 21 can be positioned in the first pulley gap 38. In another aspect, at least a portion of the second guide member 22 can be positioned in the second pulley gap 40.

In another embodiment, the pulley system 10 can comprise a top member 12, an axle 18, a pulley 20, a first guide member 21, and a second guide member 22. In one aspect, a first side leg 14 can extend from the first guide member 21, and a second side leg 16 can extend from the second guide member 22. In another aspect, the first guide member can have a length less than the diameter of the first pulley face 34.

To assemble the pulley system, in one aspect, the distal ends 24, 28 of the first side leg 14 and the second side leg 16 can be coupled to the top member 12. The first and second side legs can extend downwardly from the top member and can be substantially parallel to each other. In another aspect, the first guide member 21 can be coupled to the first side leg, and the second guide member 22 can be coupled to the second side leg. Alternatively, it is contemplated that the first and/or second guide members can be formed integrally with the respective first and second side legs 14, 16. The pulley 20 can be mounted onto the axle 18, and the ends of the axle can be coupled to the proximal ends 23, 26 of the first and second side legs to form the enclosed area 30. The mounting hook 44 can be coupled to the top member.

When assembled in this manner, the first pulley face 34 and the second pulley face 36 can be positioned adjacent the respective first and second guide members 21, 22. In one aspect, the first pulley face can contact the first guide member, and/or the second pulley face can contact the second guide member. Alternatively, in another aspect, the first pulley face 34 can be spaced from the first guide member, and/or the second pulley face 36 can be spaced from the second guide member about 0 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 40 mm, at least about 50 mm, at least about 60 mm, at least about 70 mm, at least about 80 mm, at least about 90 mm, or at least about 100 mm.

In use, in one aspect, a user can position the pulley system 10 in a desired location by, for example, selectively attaching the mounting hook 44 to a desired mounting point. An end of an item to be pulled, such as for example and without limitation, a rope, wire, cable, and chain, can be threaded through the enclosed area 30. After passing through the enclosed area, the end of the item can be pulled in a desired direction. The first and/or second guide members 21, 22 can funnel the item to the enclosed area and/or the pulling surface of the pulley 20 in order to encourage contact between the item and the pulley, so that the amount of force required to pull the item through the enclosed area can be reduced.

Thus, it is not necessary for item to be pulled to be lined up in the radial direction of the pulley in the areas adjacent the pulley system 10. In one aspect, prior to being pulled through the enclosed area 30, a rope, wire, cable, chain, and the like can be at an angle of about 10°, 20°, 30°, 40°, 45°, 50°, 60°, 70°, 80°, or 90° relative to the radial direction of the pulley 20. For example, if a cable is at an acute angle relative to the radial direction of the pulley, portions of the cable can contact the first and/or second guide members 21, 22 prior to entering the enclosed area 30, which can encourage the cable to contact the pulling surface 32 of the pulley.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A pulley system comprising:
a top member;
a first side leg and a second side leg spaced from and opposed to the first side leg, each side leg having a proximal end and a distal end, wherein the distal end of each of the first and second side legs is coupled to the top member, wherein the first side leg and the second side leg extend downwardly from the top member, and wherein the first side leg comprises a first guide member;
an axle coupled to the proximal end of each of the first and second side legs;
a pulley rotatably mounted thereon the axle, wherein the pulley has a pulling surface extending from a first pulley face to a second pulley face,
wherein the first guide member has a length less than the distance from the top member to the axle, wherein the first guide member has a length greater than the distance from the top member to an outer edge of the first pulley face, and wherein the first guide member has a width less than a diameter of the first pulley face.

2. The pulley system of claim 1, wherein a first pulley gap is formed between the first pulley face and the first side leg, and wherein at least a portion of the first guide member is positioned in the first pulley gap.

3. The pulley system of claim 2, wherein the second side leg comprises a second guide member, and wherein the second guide member has a length less than the distance from the top member to the axle.

4. The pulley system of claim 3, wherein a second pulley gap is formed between the second pulley face and the second side leg, and wherein at least a portion of the second guide member is positioned in the second pulley gap.

5. The pulley system of claim 1, wherein the first and second side legs are substantially parallel to each other.

6. The pulley system of claim 1, wherein the first guide member has a length greater than the distance from the top member to an outer edge of the first pulley face.

7. The pulley system of claim 1, wherein the first guide member has a length greater than the distance from the top member to a midpoint between the axle and the outer edge of the first pulley face.

9. The pulley system of claim 1, wherein at least a portion the first guide member extends away from the pulley at an acute angle relative to the radial direction of the pulley and at an acute angle relative to the axial direction of the pulley.

10. The pulley system of claim 1, wherein at least a portion of the first guide member is arcuate having a first guide member diameter.

11. The pulley system of claim 10, wherein at least a portion of the first guide member is substantially “C” shaped.

12. The pulley system of claim 10, wherein at least a portion of the pulling surface is arcuate having a pulling surface diameter.

13. The pulley system of claim 12, wherein the pulling surface diameter is greater than the first guide member diameter.

14. The pulley system of claim 1, further comprising a mounting hook attached to the top member.

15. The pulley system of claim 1, wherein the distance from the top member to the axle is less than the diameter of the first pulley face.

16. A pulley system comprising:
a top member;
a first guide member and a second guide member, wherein the first guide member and the second guide member are spaced from and opposed to each other, each guide member having a proximal end and a distal end, wherein the distal end of each of the first and second guide members is coupled to the top member, wherein the first guide member and the second guide member extend downwardly from the top member, wherein a first side leg extends from the first guide member, and wherein a second side leg extends from the second guide member;
an axle coupled to the proximal end of each of the first and second side legs;
a rotatable pulley mounted thereon the axle, wherein the pulley has a pulling surface extending from a first pulley face to a second pulley face,
wherein the first guide member has a length less than a diameter of the first pulley face and greater than the distance from the top member to an outer edge of the first pulley face, and wherein the first guide member has a width less than the diameter of the first pulley face.

17. The pulley system of claim 16, wherein a portion of the first guide member is arcuate having a first guide member diameter and wherein at least a portion of the pulling surface is arcuate having a pulling surface diameter.

18. The pulley system of claim 17, wherein the pulling surface diameter is greater than the first guide member diameter.

19. The pulley system of claim 17, wherein the pulling surface diameter is substantially equal to the first guide member diameter.

20. A method of pulling a cable over a pulling wheel comprising:
providing a pulley system comprising:
a top member;
a first side leg and a second side leg spaced from and opposed to the first side leg, each side leg having a proximal end and a distal end, wherein the distal end of each of the first and second side legs is coupled to the top member, wherein the first side leg and the second side leg extend downwardly from the top member, and wherein the first side leg comprises a first guide member;
an axle coupled to the proximal end of each of the first and second side legs;
a rotatable pulley mounted thereon the axle, wherein the pulley has a pulling surface extending from a first pulley face to a second pulley face, wherein the first guide member has a length less than the distance from the top member to the axle, wherein the first guide member has a length greater than the distance from the top member to an outer edge of the first pulley face, and wherein the first guide member has a width less than a diameter of the first pulley face;
placing a cable on the pulling surface around at least a portion of the pulling wheel; and
pulling the cable.
